(19) United States
(12) Patent Application Publication
(10) Pub. No.: US 2007/0234870 A1
(43) Pub. Date: Oct. 11, 2007

(54) Circular Plane Saw

(76) Inventor: Mikhail Andreevich Brabfilev, Novosibirsk (RU)

Correspondence Address: PAULEY PETERSEN & ERICKSON, 2800 WEST HIGGINS ROAD, SUITE 365, HOFFMAN ESTATES, IL, 60195, US

(21) Appl. No.: 10/586,427

(22) PCT Filed: Apr. 27, 2004
(86) PCT No.: PCT/RU04/00163

§ 371 Date: Apr. 5, 2007

(30) Foreign Application Priority Data
Jan. 20, 2004 (RU) 2004101704

(51) Int. Cl. B27B 33/02

(52) U.S. Cl. 83/852

(57) ABSTRACT

Circular plane saws for finishing longitudinal and transversal combined sawing-cutting-planing of wood, and that can be used in the wood-working industry, for instance, for high-quality sawing and planing of solid timber, tailoring of plywood, laminate, chipboards, laminated chipboards and other similar wood or wood-combined materials. This invention improves operational efficiency of saws. The right and left teeth, alternately positioned on the saw body, are made helically-shaped with the front chipper parts made in the form of a “classical” tooth part, having a rear wall of the front chipper part that passes into the rear planing/cutting part in the form of a disc segment or part with the height of the working area less than the radius of the given disc part, where the helically shaped teeth are the only type of teeth, positioned on the saw body, and the front chipper and rear planing/cutting teeth parts are made of the same or different thickness, and their tips are positioned on the same or different circumferences or diameters of the saw.

### BACKGROUND OF THE INVENTION

1. Field of the Invention

This invention relates to circular plane saws for longitudinal and transverse wood sawing/cutting/planing and for timber surface planing, such as can be used in the woodworking industry, for example, for solid timber treatment, and in furniture-making, for example, for high-quality (finishing) sawing, tailoring and planing of solid timber, plywood, laminate, chipboards, laminated boards and other similar wood or wood-combined materials.

2. Discussion of Related Art

Known circular (disc, buzz) saws with teeth, intended to cut through fibers transversely to their direction or at a certain angle, are used for wood sawing. Saws based on this cutting principle are used at woodworking enterprises and are widely described in scientific and technical literature. Circular saws for wood sawing (analogous samples) have a similar design with a circular blade, made of tool-steel, and teeth, steel teeth, or having mono- and multilayer plates and/or soldered, built-up welding, hard-alloy coatings, high-speed steels, ultra-hard materials, synthetic ultra-hard materials, synthetic polycrystalline diamonds and borazon, high-strength cutting ceramics, including nitride ceramics, positioned on the periphery. The teeth, although differing in shape, with straight, broken or curved rear wall, are designed for cutting wood fibers owing to their sharp angle between the front part and upper edge and\or side-walls and inclination towards spin.

A circular saw for wood cutting, is known from inventor's certificate No. 1207762, C1. B 27 B 33/08. A disc saw is known from inventor's certificate No. 1288060, C1. B 27 B 33/02. A circular saw with detachable teeth is known from inventor's certificate No. 1240584, C1. B27 B 33/02. A device for wood cutting is taught by a specification of invention to patent of the Russian Federation No. PU 2041799, C1. B 27 B 33/08. A device for wood cutting is taught by a specification of invention to patent of the Russian Federation No. PU 2041800, C1. B 27 B 33/08. A disc saw for longitudinal wood cutting is known from inventor's certificate No. 674899, C1. B 27 B 33/02, 1978. A circular saw is taught by a specification of invention to patent of Germany No. 24 59 514, C1. B 27 B 33/08. A circular saw is taught by a specification of invention to patent of Germany No. DE 199 14 570, C1. B 23 D 61/02. Disadvantages of the known saws include insufficient efficiency of the saw operation.

A tooth rim of finishing-cutting saw is taught by a specification of invention to patent of the Russian Federation No. RU 2053868, C1. B 27 B 33/08, and to improve working efficiency and treatment quality, the cutting edges of the chipper-planing teeth are radially convex toward a working rotation of the saw. Disadvantages include insufficient efficiency of the saw operation.

A circular planing saw for the finishing longitudinal-transverse wood cutting is taught by a specification of invention to patent of the Russian Federation No. RU 2158674, C1. B 27 B 33/02, and in order to simplify the saw design and enhance its functional capabilities, the right and left planing/cutting teeth are made with front, relieving and rear edges that can be sharpened, and are positioned with their front edges facing one or both directions of the saw disc's working rotation. Disadvantages include insufficient efficiency of the saw operation.

A “Tomahawk” circular saw for longitudinal wood cutting (for wasteless wood cutting) is known from an inventor's certificate No. 1488189, C1. B 27 B 33/02. Disadvantages include insufficient efficiency of the saw operation.

A circular saw for longitudinal wood planing (for wasteless wood cutting) is taught by a specification of invention to patent of the Russian Federation No. RU 2120852, C1. B 27 B 33/02, and in order to simplify the saw design and improve the treatment quality of wood surfaces, each cutting element (tooth) is made as a disc segment, has a single plain surface, which is positioned on one side only of the saw body in the same plane, with active edges sharpened at an angle to the saw plane, and one radially convex lateral surface, which cannot be sharpened, and is positioned on an other side of the saw body and in the same plane. Disadvantages include insufficient efficiency of the saw operation.

A circular plane saw for finishing wood-cutting, is taught by a specification of invention to patent of the Russian Federation No. RU 2149100, C1. B 27 B 33/02, and in order to simplify the saw design and improve the treatment quality of wood surfaces, the right and left planing/cutting teeth in the shape of a circle part segment are made to have a straight chipper edge, and are positioned with their chipper edges facing alternately in both directions of the working rotation of the saw blade. Disadvantages include insufficient efficiency of the saw operation.

A circular plane saw for finishing longitudinal-transversal wood cutting is taught by a specification of invention to patent of the Russian Federation No. RU 2158675, C1. B 27 B 33/02, and in order to enhance the saw functional capabilities and improve the treatment quality of wood, the chipper teeth that follow the planing/cutting teeth in each group of teeth are positioned singly or in groups, and are made binary and/or dovetail-shaped. Disadvantages include insufficient efficiency of the saw operation.

A circular longitudinal-transversal plane saw is taught by a specification of utility model to license of the Russian Federation No. RU 18974, C1. 7 B 27 B 33/02, and in order to improve the saw operational efficiency, the chipper teeth that follow the group of planing/cutting teeth in the form of a disc segment, and with front edges that face in the direction of the saw working rotation or in both directions, are made with the lips of the active edges, or all their edges ground, and with their tips made higher than the tips of the planing/cutting teeth. Disadvantages include insufficient efficiency of the saw operation.

A circular longitudinal-transversal plane saw is taught by a specification of utility model to license of the Russian Federation No. RU 18975, C1. 7 B 27 B 33/08, 33/02, and in order to improve the saw operational efficiency, the chipper teeth that follow the group of planing/cutting teeth in the form of a disc segment, are made with front, relieving and rear edges that can be sharpened, and with their tips positioned on the same or bigger diameter than the tips of the planing/cutting teeth. Disadvantages include insufficient efficiency of the saw operation.

One prototype of this invention is a circular plane saw for finishing wood sawing, such as taught by a specification of invention to patent of the Russian Federation No. RU 2124983, C1. B 27 B 33/08, and in order to simplify the saw design and improve the treatment quality of wood surfaces, in each group of teeth the right and left planing/cutting teeth, positioned alternately on the saw blade, are made in the form of a sector of a circle, have a single lateral plain edge that can be sharpened, and is positioned on the outside of the central rotational plane of the saw blade, in the same plane and with the grind at an angle to the central rotational plane of the saw blade. A single radially convex lateral edge is positioned on the inside of the central rotational plane of the saw blade and in a single plane, the chipper teeth that follow the group of the planing/cutting teeth are positioned singly or in groups with the lips of the active edges ground in the direction of the saw working rotation or in both directions, with the grind or swaging of side edges at an angle to the central rotational plane of the saw blade and with a width of the chipper teeth side edges equal or smaller than a kerf width of the planing/cutting teeth. Disadvantages include insufficient efficiency of the saw operation.

### SUMMARY OF THE INVENTION

One objective of this invention is to improve efficiency of the saw operation.

According to this invention, to improve efficiency of a saw operation, the left and right saw teeth, positioned alternately, are helically-shaped with their front chipper part shaped as a part of a “classical” tooth, and with the rear planing/cutting part made in the form of a disc segment (part), with an active area height less than the radius of the given disc part. The helically-shaped teeth are the only type of teeth on the saw body, and the front chipper parts and the rear planing/cutting parts of the teeth are of the same or different thickness, with their tips positioned on the same or different circumferences (diameters) of the saw, and the rear planing/cutting parts of these teeth are sharpened on either the lateral sides, plain or radially convex sides, or on both lateral sides.

The saw according to this invention has only one type of teeth on its body, the helically-shaped teeth, which are positioned in pairs, including the right and left tooth, where each tooth has the front chipper part followed by the rear planing/cutting part in the form of a disc segment (part). Therefore, the saw design according to this invention is simplified because it has only one type of helically-shaped teeth, which are, in addition, positioned on the saw body in a constant (fixed) sequence. The helically-shaped teeth always have their front chipper parts positioned toward the saw working rotation. They first saw the wood, clip shavings, remove saw dust and make kerf, and only after that the teeth planing/cutting parts perform the planing/cutting of wood in the area of the already existing kerf. Thus, a more optimal wood treatment is performed, as compared with the prototype performance, therefore, efficiency of the saw operation according to this invention is improved.

The prototype saw had two types of teeth, planing/cutting teeth and chipper teeth, which were not always positioned on the saw body logically, and, thus, did not always penetrated wood in the correct sequence, and treated wood likewise, which negatively influenced the wood treatment quality. Optimal wood treatment could only be performed if the wood was first penetrated by the chipper tooth, which sawed and clipped the wood, making a kerf, and only after that the planing/cutting tooth came into operation, performing the planing/cutting treatment of the kerf wall. However, the above process of wood treatment by the prototype saw was unstable. The wood was first penetrated by the planing/cutting teeth in the area of wood, where a kerf was absent, and only after that the wood was penetrated by the chipper teeth. It should be noted that the planing/cutting teeth are tapered in section, and when they penetrate wood without an existing kerf, the frictional forces in the given treatment area increase dramatically, because there is no room to move shavings aside (to the kerf s center) because the kerf is non-existent. As a result, compression of the wood occurred, with the subsequent deformation, and the saw heated, which led to further negative consequences for both the saw and wood. All that negatively influenced the wood treatment quality.

Therefore, because the saw according to this invention has teeth of only one type, which are helically-shaped and perform functions of two types of teeth, not only is the saw design simplified, but also the wood treatment quality is improved. The causes for additional frictional forces of the rear planing/cutting parts are eliminated, and other disadvantages of wood treatment are also avoided, which also demonstrates increase in efficiency of the saw operation (as compared with the prototype saw).

In addition, due to simplification of the saw design and existence of teeth of only one type, the helically-shaped teeth on the saw body, it is possible to position the planing/cutting teeth thereon at strictly fixed and equal intervals between them, regardless of the number of teeth and standard size. This makes it possible to provide not only the formation of an even kerf by the front chipper teeth parts and the further stable wood planing by the rear planing/cutting teeth parts, which produce shavings of equal thickness, but also ensures stable operation of the saw itself without side sways, which the prototype did not allow. Although, on the prototype saw, the planing/cutting and chipper teeth are positioned on the body in a certain sequence, and despite the position of the uniform teeth tips at the same distance, the distance between different types of teeth is not the same. The distance between their tips was, in practical terms, always different. Further, the number of planing/cutting and chipper teeth is not always the same, which presented a disadvantage. There are different qualities of the right- and left-hand treated wood surfaces in certain wood treatment areas, although not large ones, and, as a result, led to asymmetry of the kerf in the given wood treatment areas. In addition, the number of teeth engaged in the roughing and finishing wood treatment was often different, which also worsened the wood treatment quality. The saw according to this invention has teeth of only one type (helically-shaped teeth), which are positioned on the saw body in pairs, and which are positioned at the same distance from each other. Not only the tips of the front chipper parts are at the same distance from each other, but also the tips of the rear planing/cutting parts are positioned at the same distance from each other. The number of the right and left teeth on the saw according to this invention is always equal, and thus the number of the front chipper and rear planing/cutting teeth parts, engaged in the roughing and finishing wood treatment, would not only be always equal, but would also be always engaged in the treatment in the required (optimal) sequence and at equal intervals. During wood treatment with the saw according to this invention, a straight kerf is produced and the saw blade sway is avoided, which results in a higher wood treatment quality, as compared with the prototype saw, which also provides improvement of efficiency of the saw operation (as compared with the prototype saw).

By using teeth of only one type, which are always positioned at the same distance from each other, on the saw according to this invention, the saw is manufactured with the enhanced features of static imbalance (as compared with the prototype saw), which also has a positive effect for treatment quality improvement, including improvement of efficiency of the saw operation. At that, in order to achieve certain (acceptable) features of static imbalance and to avoid the saw blade sway of the prototype saw, there is a ratio between the number of teeth on the saw, such as 4 (right and left chipper teeth and right and left planing/cutting teeth), and the saw could have the following number of teeth: . . . , 12, 16, 20, 24, 28, 32, etc. The saw according to this invention has only one type of teeth, which are positioned at the equal distance (at equal intervals) from each other, which allows the saw to be manufactured with the enhanced features of static imbalance (as compared with the prototype saw), and requires only the teeth pairs, and the saw can have the following number of teeth: . . . , 12, 14, 16, 18, 20, 22, 24, 26, 28, 30, 32, etc. Existence of one type of helically-shaped tooth also makes it possible, as compared with the prototype saw, to position on the saw of the same diameter not only a smaller number of helically-shaped teeth (that have the front chipper parts and rear planing/cutting parts, whose operating principle, although bearing a certain likeness to the operating principle of chipper and planing/cutting teeth of the prototype saw, still differs from it significantly), but also to increase the frequency of the roughing and finishing wood treatment due to a larger number of chipper and planing/cutting teeth parts (as compared with the prototype saw). In addition, thus it is possible to enlarge the active areas of the planing/cutting parts in the form of a disc segment (part), to make their size bigger, with a bigger radius of the given disc, which also has a positive effect on improving the wood treatment quality (as compared with the prototype saw), and thus improves efficiency of the saw operation, as compared with the prototype saw.

On the saw according to this invention each helically-shaped tooth has the rear planing/cutting part in the form of a disc segment (part), with radially convex and plain sides sharpened, where the planing/cutting tooth part can be sharpened on either of the lateral sides, radially convex or plain sides, or on both lateral sides. In the case of the prototype saw, sharpening of the planing/cutting teeth can be performed on only one side, which is specified as the plain lateral sharpening surface, which made the number of possible sharpenings limited, since the planing/cutting teeth are ground dramatically thin after each sharpening. After a certain number of sharpenings of the planing/cutting teeth, the teeth of the prototype saw can reach a point when their thickness is less than that of the chipper teeth, and the saw can lose its main feature. It ceased to be efficient enough, and failed to perform a quality wood treatment, the wood treatment was performed, in effect, by the chipper teeth only, and in this case it can become just ordinary wood sawing. On the saw according to this invention, which has one type of helically-shaped teeth, the rear planing/cutting part of the teeth, in the form of a disc segment (part), is sharpened on either of the lateral sides or on both lateral sides. Due to this, the number of possible sharpenings increases, and in case of sharpening the rear planing/cutting teeth parts of the saw according to this invention, on the radially convex sides, the thickness of the rear planing/cutting parts (and the teeth as a whole), practically, does not decrease, therefore, efficiency of the saw operation increases, as compared with the prototype saw. In addition, in case of multiple sharpenings of the saw according to this invention, a decrease in thickness of the front chipper and rear planing/cutting teeth parts occurs proportionally, so that the number of the possible sharpenings grows considerably, which also demonstrates an increase in efficiency of the saw operation, as compared with the prototype saw.

On the saw according to this invention, the front chipper and rear planing/cutting teeth parts are made of the same or different thickness, and their tips are positioned on the same or different circumferences (diameters), and on the prototype saw the tips of all the planing/cutting teeth are positioned on the same diameter only. In the case, when the thickness of the planing/cutting teeth parts is greater than that of the preceding front chipper teeth parts, the front chipper teeth parts of lesser thickness perform the roughing wood treatment (sawing), while the rear planing/cutting teeth parts of greater thickness perform the finishing wood treatment (planing/cutting), to provide a double treatment of wood surface (roughing and finishing).

During the treatment of hardwood or dry wood, as well as during the transverse cutting of wood with the prototype saw, split-off and/or tearing of individual fibers from the wood surface can often occur in the process of forming and separating of shavings. The circular plane saw according to this invention eliminates these disadvantages by the presence of helically-shaped teeth, which additionally have a strictly fixed positioning sequence for the chipper and planing/cutting teeth parts, with their tips positioned on different circumferences of the saw, and which allow to provide the two-level (roughing and finishing) planing of wood surfaces. Thus, due to the positioning of only one type of helically-shaped teeth on the saw body, there also is a capability to perform treatment of different types of wood, including types with different hardness and moisture content, which also demonstrates an improvement of efficiency of the saw operation (as compared with the prototype saw). Thus, in the case of manufacture of the circular plane saw according to this invention, with the positioning of tips of the front chipper and rear planing/cutting teeth parts on different circumferences of the saw blade, and with their different thickness, the wood treatment quality improves, as compared with the prototype saw. Experiments show that in order to improve the saw efficiency (as compared with the prototype saw), it is sufficient to produce the front chipper parts of, at least, one right and one left tooth on a larger diameter (circumference) of the saw relative to other teeth parts and/or the rear planing/cutting parts of at least one right and one left tooth thicker relative to other teeth parts. Improvement of efficiency of the saw operation can occur when the thickness and positioning of tips of the front chipper and rear planing/cutting teeth parts differ by just a tenth of a millimeter. In this case, the front chipper teeth parts, positioned with their tips on the major diameter of the saw, are the first to penetrate the wood and perform the roughing wood cutting, and the thicker rear planing/cutting teeth parts, which follow the chipper parts, having their tips on the minor diameter of the saw, penetrate the wood afterwards and perform the finishing wood planing with a higher efficiency than that of the prototype saw.

Efficiency of the circular plane saw according to the proposed invention is also achieved by making the rear planing/cutting teeth parts in the form of a disc segment (part), with the active area less than the radius of the given disc. The efficiency of the saw operation depends on the ratio between the height of the rear planing/cutting tooth part in the form of a disc segment (part) and this disc radius, and a change in this ratio leads to a change in the active area of the planing/cutting tooth part, and thus to a change in the treatment quality. Experiments show that the larger the radius of the rear planing/cutting parts in the form of a disc segment (part), the larger their active areas are engaged in the wood treatment. The height of the rear planing/cutting tooth part in the form of a disc segment (part) should always be less than the radius of the given disc. Considering that the shears of the planing/cutting teeth are shaped as segment of a circle, the length of shear of the planing/cutting part in the form of a segment of a circle, engaged in wood planing/cutting, in this case will be greater than in the case of the planing/cutting teeth of the prototype saw, having a height greater or equal to the radius of the given disc. As experiments show, in order to improve efficiency of the saw operation (as compared with the prototype saw), it is advisable to have the height of the planing/cutting part of a helically-shaped tooth in the form of a disc segment (part) not larger than 1/4 - 1/6 of this disc radius. On the prototype saw, the planing/cutting teeth are made without regard to the above relation, and the height of a planing/cutting tooth is larger or equal to its radius. The angle of penetration into the wood is wider, and the active area of the planing/cutting tooth is smaller. Thus, the penetration sequence of the planing/cutting and chipper teeth was not always optimal. As opposed to that, the helically-shaped teeth of the saw according to this invention utilize a larger active area of the rear planing/cutting parts, which is engaged in the wood cutting-planing, where the wood is always penetrated first by the chipper tooth part, followed by the planing/cutting part, which also demonstrates improvement of efficiency of the saw operation (as compared with the prototype saw).

In addition, when the helically-shaped teeth of the saw according to this invention are made with their front chipper and rear planing/cutting parts of different thickness and/or positioning of the edge tips on different circumferences (diameters) of the saw, it becomes possible to combine, in one saw, the functions of the scoring and main saws, which are positioned in sequence on the woodworking machines and lines, designed, for instance, for high-precision and high-quality sawing and cutting of plywood, laminate, laminated chipboards and the like materials. Thus, the treatment of such materials is performed more efficiently, that is, improvement of efficiency of the proposed saw operation is demonstrated (as compared with the prototype saw). In this case, the chipper teeth parts are of a lesser thickness, with their tips positioned on the saw's larger circumference, and they perform the function of the scoring saw and saw the wood producing kerf width less than that produced by the rear planing/cutting teeth parts. The planing/cutting teeth parts, which are thicker and/or whose tips are positioned on the lesser diameter of the saw, perform the function of the main saw. They not only clean the wood surfaces already treated, but also plane them with a higher quality (as compared with the prototype saw), for instance, as described above. Therefore, here the combination of functions of several saws in one saw is also demonstrated, and functional capabilities are enhanced, which also demonstrates improvement of efficiency of the saw according to this invention (as compared with the prototype saw).

The circular plane saw according to this invention can be used for the wood planing. As described above, the quality of wood surfaces, which have undergone the planing, is also improved (as compared with the prototype saw), which also demonstrates the improvement of efficiency of the saw operation.

Therefore, as described above, efficiency of usage of the circular plane saw according to this invention is improved, as compared with the prototype saw, even when using only one feature of novelty of the proposed invention, the helically-shaped teeth, which also proves the improvement of efficiency of the saw operation (as compared with the prototype).

### BRIEF DESCRIPTION OF THE DRAWINGS

FIG. 1 shows the circular plane saw with helically-shaped teeth, which have hard-alloy plates soldered on;

FIG. 2 shows an enlarged segment of the circular plane saw, as shown in FIG. 1, with the tips of the front chipper and rear planing/cutting parts of the helically-shaped teeth positioned on different circumferences of the saw and of different thickness;

FIG. 3 shows a cross-section of FIG. 2; and

FIG. 4 shows the active area with the height equal h of the planing/cutting part of a helically-shaped tooth.

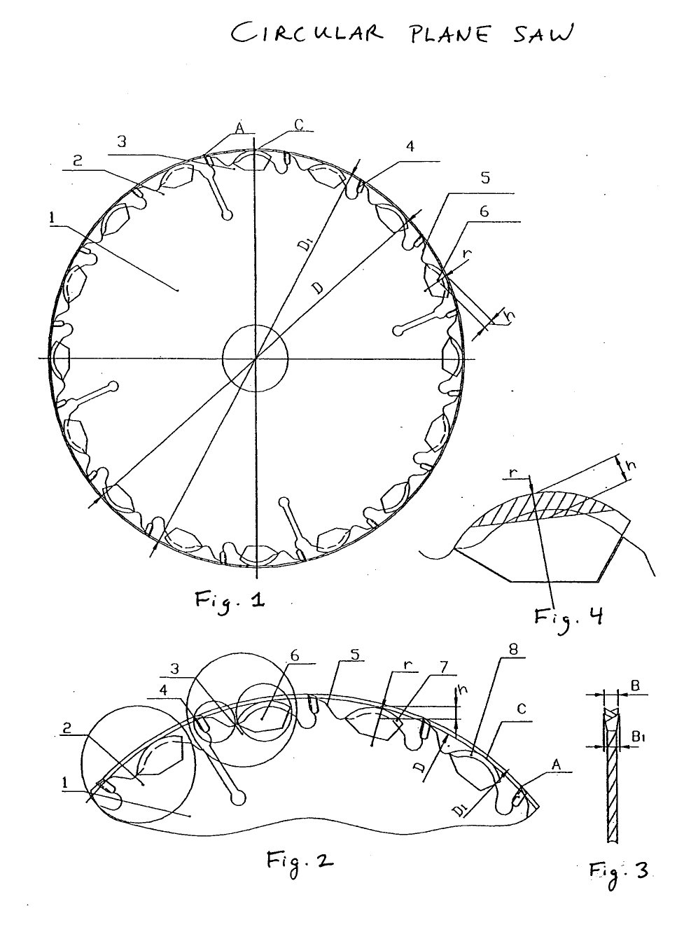

### DETAILED DESCRIPTION OF THE INVENTION

The circular plane saw includes a saw body (saw blade) 1, made of steel alloys, the right and left helically-shaped teeth 2 and 3 positioned on the saw body alternately (for instance, steel teeth or teeth with hard-alloy plates), which have their front chipper parts 4 made as a part of the “classical” tooth with a straight, broken or curved rear wall 5, which passes into the rear planing/cutting part 6 in the form of a disc segment (part), with the tip A of the front straight chipper part 4 and the tip C of the rear planing/cutting part 6 positioned on the same saw circumference D, or on different saw circumferences (diameters) D and D₁. The thickness B of the front chipper part 4 less than the thickness B₁ of the successive rear planing/cutting part 6, where the rear planing/cutting parts 6 are made of the size less than ½ of the disc part and with the height of the active part h, less than the radius r of the given disc part, and they are also sharpened on either of the lateral sides, the plain side 7 or the radially convex side 8, or on both lateral sides 7 and 8.

The saw operates in the following manner. One of the design options is for the right and left helically-shaped teeth 2 and 3, to be positioned alternately on the saw body, and be made with the front chipper parts 4 as a part of a “classical” tooth, and the rear planing/cutting parts 6 in the form of a disc segment (part) of different thickness B [symbol] B₁, and with their tips A and C positioned on different circumferences D and D₁ of the saw, where the rear planing/cutting parts 6 are made of the size less than ½ of the disc part and the height equal h, less than the radius r of the given disc part, to be sharpened on either of the lateral sides, the plain side 7 or the radially convex side 8, or both lateral sides 7 and 8.

During rotation of the saw blade 1, the right helically-shaped tooth 2, with the help of its chipper part 4, having a straight, broken or curved rear wall 5, the tip A of the front straight chipper part 4 is positioned on the saw circumference D and higher than the tip C of the successive rear planing/cutting part 6, which is positioned on the lesser diameter D₁ of the saw, and the thickness B of the front chipper part 4 is less than the thickness B₁ of the successive rear planing/cutting part 6, penetrates the wood, splits, tears and cuts the wood fibers and removes the powdered fibers, which have the form of saw-dust, the kerf produced, and clips the shavings inside the kerf, cuts the shavings into smaller fragments and removes them from the wood, while the roughing wood cutting/sawing is performed. Following the front chipper part 4, the wood is penetrated by the rear planing/cutting part 6, made in the form of a disc part with the thickness B₁ and its tip C positioned on the saw's circumference (diameter) D₁, and the finishing wood planing/cutting is performed, where shavings are produced and moved to the center of the kerf produced. After that, the next left helically-shaped tooth 3 penetrates the wood and the wood treatment process, described above, is repeated.

The uniformly sharpened rear planing/cutting parts 6, due to their shape in the form of a disc segment (part) and the height of the active area equal h, less than the radius r of the given disc part, perform the wood cutting/planing similarly to the cutting/planing process, which is performed at a certain stage of the wood cutting/planing by a plane knife of a planing machine, and during the process of cutting by a guillotine-type knife of a slicing machine, which allows high quality surface treatment of the wood to be achieved, comparable to the wood treatment quality achieved by the planing and cutting machines.

In order to perform only the process of wood surface planing, it is necessary to set a thickness of the wood sawing/cutting/planing equal to or less than the thickness of the circular plane saw. In order to achieve a greater saving mode of wood planing, the thickness of the wood layer removed should be less than that of the circular plane saw.

1. A circular plane saw, having a steel saw blade, with teeth groups made at least one of steel, monolayer plates, multilayer plates, soldering, build-up welds, coatings of hard-alloy and high-speed steels, synthetic ultra-hard materials, synthetic polycrystalline diamonds and borazon, high-strength cutting ceramics, nitride ceramics, and other hard and ultra-hard materials, positioned at a periphery, right and left planing/cutting teeth in a form of a disc part having one plain lateral surface which can be sharpened and one radially convex lateral surface which cannot be sharpened, and chipper teeth each with a straight chipper edge, which follow the group of planing/cutting teeth, of one or different standard size and thickness, positioned a single or in a group, with front edges facing toward a working rotation of the saw, or in both directions, and with at least the working edges, sharpened, and a thickness of the chipper teeth equal to or less than of the right and left planing/cutting teeth, the improvement comprising: the right saw teeth and the left saw teeth positioned alternately on the saw body and helically-shaped with the front chipper parts formed as a classical tooth part and the rear planing/cutting part formed as a disc segment with a height of an active area less than a radius of a given disc part, the helically-shaped teeth are an only type of teeth, positioned on the saw body, and the front chipper and the rear planing/cutting teeth parts are made of one of a same thickness and a different thickness with tips positioned on one of circumferences and diameters of the saw, and the rear planing/cutting parts of the teeth are sharpenable on at least one of the lateral sides, the plain or radially convex sides, and both lateral sides.
